(19) United States
(12) Patent Application Publication
(10) Pub. No.: US 2025/0242793 A1
(43) Pub. Date: Jul. 31, 2025

(54) STABILIZATION FACTORS AND APPROACHES IN REAL-TIME VEHICLE POWERTRAIN MODE OPTIMIZATION

(71) Applicant: FCA US LLC, Auburn Hills, MI (US)

(72) Inventors: Harshal S Kudupley, Bloomfield Hills, MI (US); Nadirsh Patel, Farmington Hills, MI (US); Andryas Mawardi, Rochester, MI (US)

(21) Appl. No.: 18/428,189

(22) Filed: Jan. 31, 2024

(51) Int. Cl. B60W 20/15; B60W 30/14

(52) U.S. Cl. CPC B60W 20/15; B60W 30/143

(57) ABSTRACT

A powertrain mode optimization system for a powertrain of a vehicle includes a control system configured to determine a current operating mode of a powertrain that includes at least an internal combustion engine and a multi-speed automatic transmission configured to generate drive torque to a driveline of the vehicle, calculate, for each of a plurality of operating modes and based on the set of operating parameters, a cost indicative of a mathematical entity for a particular operating mode quantifying an affinity to choose that particular operating mode, calculate, for each of the plurality of operating modes and based on the set of operating parameters, an energy-based cost offset or penalty associated with operating in the respective operating mode, and, based on the calculated costs and energy-based cost offsets or penalties, determine which of the plurality of operating modes in which to operate the powertrain.

### FIELD

The present application generally relates to vehicle powertrain mode control and, more particularly, to stabilization factors and approaches in real-time vehicle powertrain mode optimization.

### BACKGROUND

A vehicle powertrain is typically operable in a plurality of different modes, especially in the case of hybrid vehicles/powertrains. The parameters that define these different modes include, for example only, transmission settings (e.g., gear ratio), engine settings (valve lift, fuel, spark, etc.), and hybrid powertrain settings (engine on/off, motor(s) engaged/disengaged, clutch states, etc.). Traditional techniques for mode optimization utilize an optimization cost function along with stabilization costs that remove/mitigate expected noise. This stabilization could result in a sub-optimal mode being selected for an extended period of time, particularly in a steady or pseudo steady-state of the powertrain. For example, this could include operating in cruise control with a set speed and without any major changes in road grade. Accordingly, while such conventional vehicle powertrain mode optimization systems do work for their intended purpose, there exists an opportunity for improvement in the relevant art.

### SUMMARY

According to one example aspect of the invention, a powertrain mode optimization system for a powertrain of a vehicle is presented. In one exemplary implementation, the powertrain mode optimization system comprises a set of sensors configured to measure a set of operating parameters of the vehicle, the set of operating parameters being relating to a plurality of operating modes of the powertrain, wherein the powertrain includes at least an internal combustion engine and a multi-speed automatic transmission configured to generate drive torque to a driveline of the vehicle and a control system configured to determine a current operating mode of the powertrain of the plurality of operating modes of the powertrain, calculate, for each of the plurality of operating modes and based on the set of operating parameters, a cost indicative of a mathematical entity for a particular operating mode quantifying an affinity to choose that particular operating mode, calculate, for each of the plurality of operating modes and based on the set of operating parameters, an energy-based cost offset or penalty associated with operating in the respective operating mode, and based on the calculated costs and energy-based cost offsets or penalties, determine which of the plurality of operating modes in which to operate the powertrain.

In some implementations, the control system is configured to calculate the energy-based cost offset or penalty by accumulating or integrating a difference in raw costs for a raw desired powertrain mode and a current powertrain mode over a future period. In some implementations, the optimal powertrain mode is defined as:

min(C_{A},C_{B},C_{C}),

where C_{A}, C_{B}, and C_{C} represent the costs of powertrain modes A, B, and C, respectively, and current powertrain mode A has a highest cost and:

$${C}_{B} = {C}_{RB} + {O}_{B}$$

$${C}_{C} = {C}_{RC} + {O}_{C} ,$$

where C_{RB} and O_{B} represent the raw and offset or penalty costs of powertrain mode Band C_{RC} and O_{C} represent the raw and offset or penalty costs of powertrain mode C, respectively. In some implementations, the energy-based cost offset or penalty (γ) is defined as:

$$γ = - {\int }_{0}^{{t}_{{O}_{B - {O}_{C}}}} F ( {C}_{RB} - {C}_{RC} ) dt ,$$

where F represents an integration factor function ƒ(n) of a particular powertrain mode.

In some implementations, the control system is further configured to reset the energy-based cost offset or penalty γ resets after a powertrain mode transition. In some implementations, the control system is further configured to perform periodic cost-based transition checks during steady-state periods. In some implementations, a value the cost for each particular operating mode is made up of (i) an amount of power consumed, (ii) a drivability-based bias cost, and (iii) a component-based penalty cost. In some implementations, the vehicle is a hybrid vehicle and the powertrain is a hybrid powertrain including the engine and at least one electric motor. In some implementations, the control system is configured to not continue operating the powertrain in a sub-optimal mode during an extended steady-state period. In some implementations, the extended steady-state period includes operating the powertrain in a cruise control mode with a set vehicle speed and minimal or no changes in road grade.

According to another example aspect of the invention, a powertrain mode optimization method for a powertrain of a vehicle is presented. In one exemplary implementation, the powertrain mode optimization method comprises receiving, by a control system and from a set of sensors, a set of operating parameters of the vehicle, the set of operating parameters relating to a plurality of operating modes of the powertrain, wherein the powertrain includes at least an internal combustion engine and a multi-speed automatic transmission configured to generate drive torque to a driveline of the vehicle, determining, by the control system, a current operating mode of the powertrain of the plurality of operating modes of the powertrain, calculating, by the control system for each of the plurality of operating modes and based on the set of operating parameters, a cost indicative of a mathematical entity for a particular operating mode quantifying an affinity to choose that particular operating mode, calculating, by the control system for each of the plurality of operating modes and based on the set of operating parameters, an energy-based cost offset or penalty associated with operating in the respective operating mode, and based on the calculated costs and energy-based cost offsets or penalties, determining, by the control system, which of the plurality of operating modes in which to operate the powertrain.

In some implementations, wherein calculating the energy-based cost offset or penalty includes accumulating or integrating, by the control system, a difference in raw costs for a raw desired powertrain mode and a current powertrain mode over a future period. In some implementations, the optimal powertrain mode is defined as:

min(C_{A},C_{B},C_{C}),

where C_{A}, C_{B}, and C_{C} represent the costs of powertrain modes A, B, and C, respectively, and current powertrain mode A has a highest cost and:

$${C}_{B} = {C}_{RB} + {O}_{B}$$

$${C}_{C} = {C}_{RC} + {O}_{C} ,$$

where C_{RB} and O_{B} represent the raw and offset or penalty costs of powertrain mode Band C_{RC} and O_{C} represent the raw and offset or penalty costs of powertrain mode C, respectively. In some implementations, the energy-based cost offset or penalty (γ) is defined as:

$$γ = - {\int }_{0}^{{t}_{{O}_{B - {O}_{C}}}} F ( {C}_{RB} - {C}_{RC} ) dt ,$$

where F represents an integration factor function ƒ(n) of a particular powertrain mode.

In some implementations, the method further comprises resetting, by the control system, the energy-based cost offset or penalty γ resets after a powertrain mode transition. In some implementations, the method further comprises performing, by the control system, periodic cost-based transition checks during steady-state periods. In some implementations, a value the cost for each particular operating mode is made up of (i) an amount of power consumed, (ii) a drivability-based bias cost, and (iii) a component-based penalty cost. In some implementations, the vehicle is a hybrid vehicle and the powertrain is a hybrid powertrain including the engine and at least one electric motor. In some implementations, the control system is configured to not continue operating the powertrain in a sub-optimal mode during an extended steady-state period. In some implementations, the extended steady-state period includes operating the powertrain in a cruise control mode with a set vehicle speed and minimal or no changes in road grade.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a powertrain and an example powertrain mode optimization system according to the principles of the present application;

FIG. 2 is a flow diagram of an example powertrain mode optimization method for a powertrain of a vehicle according to the principles of the present application; and

FIG. 3 is a graph or plot of example vehicle powertrain modes, their respective costs, and the application of stabilization offsets/penalties thereto according to the principles of the present application.

### DESCRIPTION

As previously discussed, traditional vehicle powertrain mode optimization techniques utilize an optimization cost function along with stabilization costs that remove/mitigate expected noise. This stabilization could result in a sub-optimal mode being selected for an extended period of time, particularly in a steady or pseudo steady-state of the powertrain. For example, this could include operating in cruise control with a set speed and without any major changes in road grade. Generally, in vehicles with an internal combustion engine, a cost surface used for representing the cost of operating the engine has a significant slope. This slope in the raw engine cost allows the system to overcome the stabilization penalties applied, with subtle changes that take place in driver torque requests. In hybrid electric modes (or fully-electric modes), the cost surface of operating an electric motor over its torque and speed range is quite flat, as these machines are very efficient. This translates in unstable raw optimum solutions that can flicker from mode-to-mode for very minor changes in inputs. Applying static stabilization penalties can overcome this issue; however, this also results in the problem described above where the system can be stuck in these sub-efficient states in many steady state driving scenarios.

Accordingly, improved vehicle powertrain optimization systems and methods are presented herein. Specifically, the present application discloses new techniques that post-process raw state determinations to incorporate a stabilization penalty. This is due to an instantaneous or authentic determined optimum state being unable to be actuated or achieved due to real-world drivability concerns (e.g., noise/vibration/harshness, or NVH). The penalty is shaped by a range of factors including, but not limited to, vehicle speed, road grade, accelerator pedal input, temperature, and navigation system data. In response to identified steady-state periods, an “energy-based” mitigation of the stabilization offsets/penalties is employed, thereby permitting the system to gravitate towards its authentic optimum state while still upholding the desired hysteresis in alternate transient scenarios. In particular, for an electric or hybrid powertrain vehicle, it is critically important to determine the most efficient powertrain mode to maximize fuel/electrical energy economy. These considerations are critical to the overall powertrain mode determination formulation.

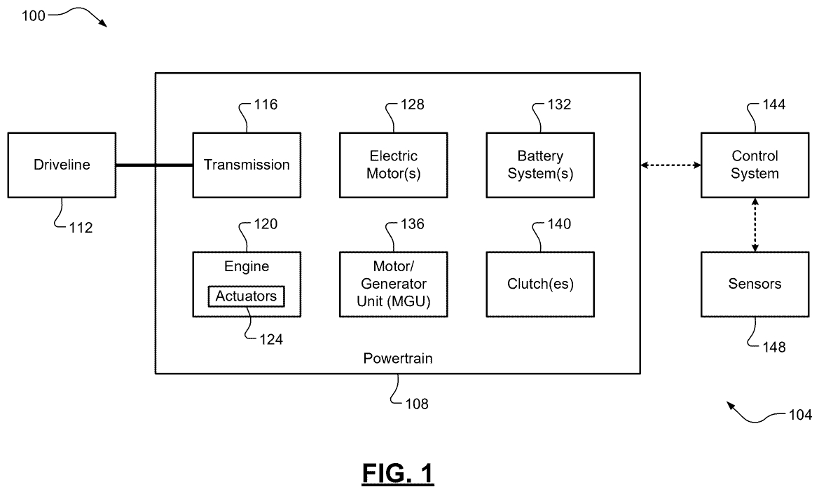

Referring now to FIG. 1, a functional block diagram of a vehicle 100 having an example powertrain optimization system 104 according to the principles of the present application is illustrated. The vehicle 100 generally comprises a powertrain 108 configured to generate drive torque that is transferred to a driveline 112 via a transmission 116. The transmission 116 is a multi-speed (e.g., step-gear) automatic transmission having a plurality of different selectable gear ratios that are part of a plurality of operating modes of the powertrain 108. The powertrain 108 includes an internal combustion engine 120 that is configured to combust a mixture of air and liquid fuel (gasoline, diesel, etc.) within cylinders to generate drive torque. The engine includes a plurality of actuators 124 configured to control a torque output of the engine 120 that are part of the plurality of operating modes of the powertrain 108. This includes, for example only, air/exhaust flow (throttle valve, intake/exhaust valve lift, supercharger/turbocharger pressure, etc.), fuel (e.g., fuel injection pulse-width), and spark (e.g., spark timing, such as spark retardation).

In some implementations, the vehicle 100 is a hybrid vehicle and the powertrain 108 is a hybrid powertrain that further includes one or more electric motors. This could include one or more electric traction motors 128 that are powered by one or more respective battery systems 132 and/or a motor/generator unit (MGU) 136 connectable to the engine 120 and configured to generate electrical energy for recharging the one or more battery systems 132. The hybrid configuration of the powertrain 108 could also include one or more clutches 140 (e.g., disconnect clutch(es) or the like) that are utilized to selectively connect/disconnect the various torque generating systems described above and shown in FIG. 1 from a power flow to the driveline 112 via the transmission 116. A controller or control system 144 is configured to control the vehicle 100, including controlling the powertrain 108 according to one of the plurality of operating modes. This control is based on gathered inputs/data from a plurality of sensors 148 configured to measure/monitor operating parameters of the vehicle 100, such as a driver torque request via an accelerator pedal or the like.

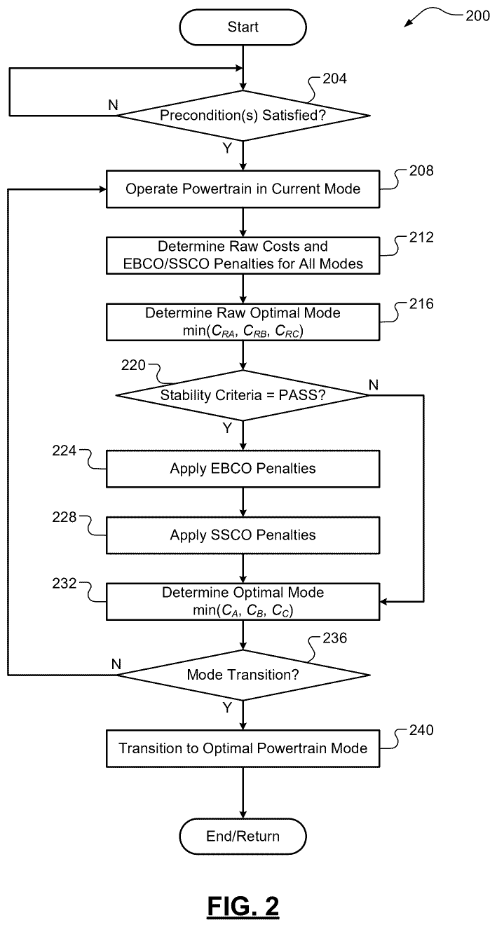

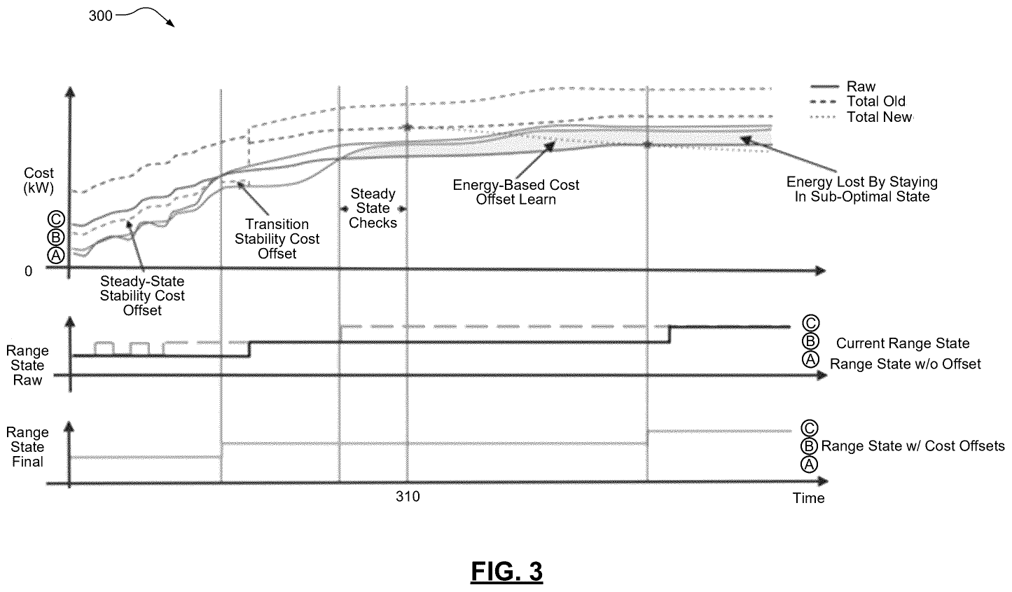

Referring now to FIGS. 2-3 and with continued reference to FIG. 1, a flow diagram of an example powertrain mode optimization method 200 for a powertrain of a vehicle according to the principles of the present application and a graph or plot 300 of example vehicle powertrain modes, their respective costs, and the application of stabilization offsets/penalties thereto according to the principles of the present application are illustrated, respectively. While the method 200 specifically references the vehicle 100 and its components, it will be appreciated that the method 200 could be applicable to any suitably configured vehicle (an engine-only powertrain with a multi-speed/step-gear automatic transmission, a hybrid powertrain, etc.). The method 200 begins at 204. At 204, the control system 144 determines whether an optional set of one or more preconditions have been satisfied. This could include, for example only, the powertrain 108 being powered up and running and there being no malfunctions or faults present that would negatively impact or otherwise inhibit the operation of the techniques of the present application. When false, the method 200 ends or returns to 204. When true, the method 200 proceeds to 208.

At 208, the control system 144 operates the powertrain 108 in a first powertrain mode (mode A) of a plurality different powertrain modes and, at 212, the control system 144 determines, for each of the plurality of powertrain modes, respective costs. The term “mode” in describing the operation of the powertrain 108 refers to a current configuration or state of the powertrain 108 and its various devices. The term “cost” in describing a powertrain mode refers to a mathematical entity for a powertrain mode quantifying the system's affinity to choose that mode. The value of the cost is made up of, for example, amount of power consumed (physics of mode), bias cost (subjective factors, noise/vibration/harshness, drivability, etc.) and penalty cost (component constraints) and may be based on the set of operating parameters (e.g., from sensors 148). For purposes of this description, three generic powertrain modes (modes A, B, and C, modes 1-3, etc.) are described/referenced herein and shown in the plot 300 of FIG. 3. It will be appreciated, however, that there could be more than three different powertrain modes and potentially many more than three different powertrain modes. The following parameters define the powertrain modes or states:

Cₙ=Total Cost for Mode n;

C_{Rn}=Raw Cost for Mode n;

Oₙ=Cost Offset for Mode n; and

Thus, the following equation (Equation 1) defines the costs for each of the n powertrain modes:

$${C}_{n} = {C}_{Rn} + {O}_{n} . \qquad ( 1 )$$

The optimal powertrain mode is thus defined as:

$$min ( {C}_{A} , {C}_{B} , {C}_{C} ) . \qquad ( 2 )$$

where C_{A}, C_{B}, and C_{C} represent the costs of powertrain modes A, B, and C, respectively. We will now examine the example scenario (see time/line 310 in FIG. 3) where the current powertrain mode (mode A) has a highest cost and where C_{B} and C_{RC} are the modes or states with the lowest total cost and raw cost candidates desired:

$${C}_{B} = {C}_{RB} + {O}_{B} , and$$

$${C}_{C} = {C}_{RC} + {O}_{C} .$$

where C_{RB} and O_{B} represent the raw and offset or penalty costs of powertrain mode Band C_{RC} and O_{C} represent the raw and offset or penalty costs of powertrain mode C, respectively. Each offset or penalty cost includes both a steady-state cost offset (SSCO) value or penalty and an energy-based cost offset (EBCO) value or penalty.

At 216, the control system 144 determines the raw optimal powertrain mode (e.g., min(C_{RA}, C_{RB}, C_{RC}). At 220, the control system 144 determines whether a set of stability criteria are satisfied (e.g., a PASS status as opposed to a FAIL status). In order words, this check determines whether the powertrain 108 is currently operating at steady-state (i.e., non-transient) operating conditions where cost checks and potential mode transitions could occur. For example only, this could include a cruise control mode of the vehicle 100 being enabled with zero or minimal change in road grade (and thus steady-speed state vehicle speed conditions). When false, the method 200 proceeds to 232. Returning to the previous example with powertrain modes A, B, and C, it is desirable to transition from the highest-cost mode A to one of the other modes. Again, for reference:

$${C}_{B} = {C}_{RB} + {O}_{B} , and$$

$${C}_{C} = {C}_{RC} + {O}_{C} .$$

As also mentioned before,

C_{B}<C_{C}, and

C_{RC}<C_{RB}.

By substituting the following equations/inequalities, we obtain the following:

$${C}_{C} - {O}_{C} < {C}_{B} - {O}_{B} .$$

Thus, the cost for C_{B} to overcome the stabilization penalties is shown and highlighted below:

$${C}_{B} > {C}_{C} + {O}_{B} - {O}_{C} .$$

The final system desired state is powertrain mode B considering only the SSCO values or penalties. However, there are also EBCO values or penalties for consideration. The EBCO value or penalty (γ) is defined as:

$${C}_{B} > {C}_{C} + {O}_{B} - {O}_{C} + γ , and$$

$$γ = - {\int }_{0}^{{t}_{{O}_{B - {O}_{C}}}} F ( {C}_{RB} - {C}_{RC} ) dt ,$$

where F represents an integration factor function ƒ(n) of a particular powertrain mode. In other words, the EBCO value or penalty γ represents difference in the raw costs for raw desired and current state used to integrate down O_{B}-O_{C} over the time t_{O}_{_{B}}_{-O}_{_{C}} and, after the time t_{O}_{_{B}}_{-O}_{_{C}} due to a state transition, γ is reset. Over a steady-state, γ causes the powertrain mode transition from sub-optimal mode B to optimal mode C. In some implementations, the EBCO value or penalty γ resets (e.g., by the control system 144) after a powertrain mode transition (see steps 236-240). The control system 144 applies these EBCO and SSCO values or penalties at 224 and 228 and the method 200 then proceeds to 232.

At 232, the control system 144 determines the optimal powertrain mode after the selective application of the EBCO and SSCO values or penalties at 224 and 228. This optimal powertrain mode is the powertrain mode having a minimal post-processed cost, e.g., min(C_{A}, C_{B}, C_{C}). At 236, the control system 232 determines whether a powertrain mode transition is necessary (i.e., whether the optimal powertrain mode determined at 232 differs from the current powertrain mode). In the detailed example above, there would be a powertrain mode transition from mode A to mode C. As previously discussed herein, the powertrain mode transition could involve enabling/disabling any of the engine 120 (and, if applicable, the MGU 136), the electric motor(s) 132, the clutch(es) 140, the transmission 116, etc. When a powertrain mode transition is not necessary, the method 200 returns to 208. Otherwise, the method 200 proceeds to 240 where the control system 144 executes the powertrain mode transition by controlling the powertrain 108 accordingly and the method 200 then ends or returns to 204 or 208 for one or more additional cycles.

The techniques of the present application can be generally summarized as follows. First (1), to achieve stable and robust decision making while satisfying the conflicting constraints, the raw state decisions are post processed. Second (2), this post-processing stage entails the incorporation of a stabilization penalty. This penalty is shaped by a range of influences including but not confined to vehicle speed, gradient, accelerator pedal input, temperature, and GPS data, etc. is augmented to the raw cost associated with each distinct powertrain state, as defined by the mathematical cost formulation. The visual representation depicted in FIG. 3 elucidates this concept. The solid signals/lines delineate the raw costs tied to discrete powertrain states available to the vehicle 100 (A, B, and C). Upon introduction of stabilization penalties, these signals transform into the respective dashed lines, their adjustment determined by the factors outlined in (2). Consequently, the ultimate state decision crystallizes from the most efficient option subsequent to the application of stabilization penalties. This strategic application of penalties ensures system stability, considering the inherently transitory nature of the raw inputs under consideration.

While this meets the stability criteria for typical systems, certain instances arise wherein the raw cost differential between states lacks the potency to surmount the impact of stabilization penalties. In these types of systems, stabilization penalties can make the final state decision become sub optimal in transient as well as steady states. To circumvent this challenge, the system identifies periods of stead-state, a determination influenced by a spectrum of parameters including, though not limited to, vehicle speed, road grade/gradient, accelerator pedal input, temperature, and GPS data, etc. Subsequently, the system initiates an “energy-based” mitigation of the stabilization offsets or penalties, permitting the system to gravitate toward its authentic optimum state while upholding the desired hysteresis in alternate transient scenarios. This intricate interplay is explicated through the equations presented herein as well as the illustrative FIG. 3. Potential benefits of these new/improved techniques include improved vehicle efficiency and/or improved vehicle drivability.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A powertrain mode optimization system for a powertrain of a vehicle, the powertrain mode optimization system comprising:
a set of sensors configured to measure a set of operating parameters of the vehicle, the set of operating parameters being relating to a plurality of operating modes of the powertrain, wherein the powertrain includes at least an internal combustion engine and a multi-speed automatic transmission configured to generate drive torque to a driveline of the vehicle; and
a control system configured to:
determine a current operating mode of the powertrain of the plurality of operating modes of the powertrain;
calculate, for each of the plurality of operating modes and based on the set of operating parameters, a cost indicative of a mathematical entity for a particular operating mode quantifying an affinity to choose that particular operating mode;
calculate, for each of the plurality of operating modes and based on the set of operating parameters, an energy-based cost offset or penalty associated with operating in the respective operating mode; and
based on the calculated costs and energy-based cost offsets or penalties, determine which of the plurality of operating modes in which to operate the powertrain.

2. The powertrain mode optimization system of claim 1, wherein the control system is configured to calculate the energy-based cost offset or penalty by accumulating or integrating a difference in raw costs for a raw desired powertrain mode and a current powertrain mode over a future period.

3. The powertrain mode optimization system of claim 1, wherein the optimal powertrain mode is defined as:
min(C_{A},C_{B},C_{C}),
where C_{A}, C_{B}, and C_{C} represent the costs of powertrain modes A, B, and C, respectively, and current powertrain mode A has a highest cost and:
$${C}_{B} = {C}_{RB} + {O}_{B}$$
$${C}_{C} = {C}_{RC} + {O}_{C} ,$$
where C_{RB} and O_{B} represent the raw and offset or penalty costs of powertrain mode Band C_{RC} and O_{C} represent the raw and offset or penalty costs of powertrain mode C, respectively.

4. The powertrain mode optimization system of claim 3, wherein the energy-based cost offset or penalty (γ) is defined as:
$$γ = - {\int }_{0}^{{t}_{{O}_{B - {O}_{C}}}} F ( {C}_{RB} - {C}_{RC} ) dt ,$$
where F represents an integration factor function ƒ(n) of a particular powertrain mode.

5. The powertrain mode optimization system of claim 4, wherein the control system is further configured to reset the energy-based cost offset or penalty γ resets after a powertrain mode transition.

6. The powertrain mode optimization system of claim 1, wherein the control system is further configured to perform periodic cost-based transition checks during steady-state periods.

7. The powertrain mode optimization system of claim 1, wherein a value the cost for each particular operating mode is made up of (i) an amount of power consumed, (ii) a drivability-based bias cost, and (iii) a component-based penalty cost.

8. The powertrain mode optimization system of claim 1, wherein the vehicle is a hybrid vehicle and the powertrain is a hybrid powertrain including the engine and at least one electric motor.

9. The powertrain mode optimization system of claim 1, wherein the control system is configured to not continue operating the powertrain in a sub-optimal mode during an extended steady-state period.

10. The powertrain mode optimization system of claim 9, wherein the extended steady-state period includes operating the powertrain in a cruise control mode with a set vehicle speed and minimal or no changes in road grade.

11. A powertrain mode optimization method for a powertrain of a vehicle, the powertrain mode optimization method comprising:
receiving, by a control system and from a set of sensors, a set of operating parameters of the vehicle, the set of operating parameters relating to a plurality of operating modes of the powertrain, wherein the powertrain includes at least an internal combustion engine and a multi-speed automatic transmission configured to generate drive torque to a driveline of the vehicle;
determining, by the control system, a current operating mode of the powertrain of the plurality of operating modes of the powertrain;
calculating, by the control system for each of the plurality of operating modes and based on the set of operating parameters, a cost indicative of a mathematical entity for a particular operating mode quantifying an affinity to choose that particular operating mode;
calculating, by the control system for each of the plurality of operating modes and based on the set of operating parameters, an energy-based cost offset or penalty associated with operating in the respective operating mode; and
based on the calculated costs and energy-based cost offsets or penalties, determining, by the control system, which of the plurality of operating modes in which to operate the powertrain.

12. The powertrain mode optimization method of claim 11, wherein calculating the energy-based cost offset or penalty includes accumulating or integrating, by the control system, a difference in raw costs for a raw desired powertrain mode and a current powertrain mode over a future period.

13. The powertrain mode optimization method of claim 11, wherein the optimal powertrain mode is defined as:
min(C_{A},C_{B},C_{C}),
where C_{A}, C_{B}, and C_{C} represent the costs of powertrain modes A, B, and C, respectively, and current powertrain mode A has a highest cost and:
$${C}_{B} = {C}_{RB} + {O}_{B}$$
$${C}_{C} = {C}_{RC} + {O}_{C} ,$$
where C_{RB} and O_{B} represent the raw and offset or penalty costs of powertrain mode Band C_{RC} and O_{C} represent the raw and offset or penalty costs of powertrain mode C, respectively.

14. The powertrain mode optimization method of claim 13, wherein the energy-based cost offset or penalty (γ) is defined as:
$$γ = - {\int }_{0}^{{t}_{{O}_{B - {O}_{C}}}} F ( {C}_{RB} - {C}_{RC} ) dt ,$$
where F represents an integration factor function ƒ(n) of a particular powertrain mode.

15. The powertrain mode optimization method of claim 14, further comprising resetting, by the control system, the energy-based cost offset or penalty γ resets after a powertrain mode transition.

16. The powertrain mode optimization method of claim 12, further comprising performing, by the control system, periodic cost-based transition checks during steady-state periods.

17. The powertrain mode optimization method of claim 11, wherein a value the cost for each particular operating mode is made up of (i) an amount of power consumed, (ii) a drivability-based bias cost, and (iii) a component-based penalty cost.

18. The powertrain mode optimization method of claim 11, wherein the vehicle is a hybrid vehicle and the powertrain is a hybrid powertrain including the engine and at least one electric motor.

19. The powertrain mode optimization method of claim 11, wherein the control system is configured to not continue operating the powertrain in a sub-optimal mode during an extended steady-state period.

20. The powertrain mode optimization method of claim 19, wherein the extended steady-state period includes operating the powertrain in a cruise control mode with a set vehicle speed and minimal or no changes in road grade.
